(19) United States
(12) Patent Application Publication
(10) Pub. No.: US 2008/0234897 A1
(43) Pub. Date: Sep. 25, 2008

(54) Power Supply Controller

(75) Inventor: Katsumi Tsuchida, Aichi-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toyota Jidosha Kabushiki Kaisha, Toyota-shi (JP)

(21) Appl. No.: 12/090,102

(22) PCT Filed: Nov. 17, 2006
(86) PCT No.: PCT/IB2006/003245

§ 371 Date: Apr. 14, 2008

(30) Foreign Application Priority Data
Nov. 21, 2005 (JP) 2005-335254

(51) Int. Cl. B62D 5/04; H02P 7/00

(52) U.S. Cl. 701/42; 318/139; 903/942

(57) ABSTRACT

A power supply controller controls the output of a DC/DC converter, so that the power output can be used not only by an electrical power steering apparatus, but by other operating/driving controllers as well. The controller may command the DC/DC converter to reduce the voltage of the high-voltage battery to a prescribed voltage or to boost the voltage of the low-voltage battery to a prescribed voltage when appropriate. In addition, the controller may also command the gradual reduction of the power supplied by the DC/DC converter to the power steering apparatus. The gradual reduction in power prevents a sudden change in the steering feel, which improves drivability of the vehicle.

### BACKGROUND OF THE INVENTION

1. Field of the Invention

The present invention relates to a power supply controller that uses a high-voltage battery that serves as the drive power supply for a vehicle drive motor, for example, to cause operation of an operating/driving controller such as for electric power steering.

2. Description of the Related Art

Conventionally, a hybrid, vehicle having an engine and a drive motor, is configured with a high-voltage battery that supplies electrical power to the drive motor. The high-voltage battery is generally called the main battery.

Electric power steering apparatuses that impart steering assist force to rotate a steering wheel consume a large amount of electrical power, and hybrid vehicles are sometimes configured so that the main battery powers the electric power steering apparatus.

For example, as shown in FIG. 8, a DC/DC converter 120 is provided between the high-voltage battery 100 and the electric power steering apparatus 110 to adjust the voltage supplied to the electric power steering apparatus 110 to be suitable to drive the electric motor 111 of the electric power steering apparatus 110.

The hybrid controller 130 that controls the hybrid system (hereinafter referred to as HV-ECU 130) controls the supply of electrical power from the high-voltage battery 100 to the hybrid system, and also outputs to the controller 112 of the electric power steering apparatus 110 (hereinafter EPS-ECU 112) an enable signal that enables the use of the main battery 100 and a disable signal that disables use thereof.

The command signals from this HV-ECU 130 to the EPS-ECU 112 are transmitted using a CAN (Controller Area Network) communication system that transmits on a single-pair communication bus 140 between various control units and sensors within the vehicle.

The EPS-ECU 112 controls the starting and stopping of the DC/DC converter 120 based on the control command signals sent from the HV-ECU 130 (enable signal and disable signal). Essentially, the control line 150 is disposed between the EPS-ECU 112 and the DC/DC converter 120 and, when the enable signal is received, the operating power supply of the DC/DC converter 120 turned on condition and voltage is reduced, and when the disable signal is received, the operating power supply of the DC/DC converter 120 is turned off, thereby stopping operation thereof.

A communication bus 151 is connected to the DC/DC converter 120 to allow transmission of abnormal condition information, such as overheating, over-current and the like, to the EPS-ECU 112 during the voltage-reducing operation. Although such art is not noted in patent disclosures and the like, art for boosting the voltage of a battery for supply to an electric power steering apparatus is described in Japanese Patent Application Publication No. 2005-212659 and Japanese Patent Application Publication No. S64-44377.

In the above-described power supply system configuration, however, it is not possible to use the power supply output of the DC/DC converter 120 in other control systems. Essentially, because the operation of a DC/DC converter 120 is controlled for the purpose of only the electric power steering apparatus 110, if an attempt is made to use the power supply output of the DC/DC converter 120 for a different control system, there is a possibility that the power required by that control system will be interrupted.

Another problem is that, in a conventional power supply system, operation of the electric power steering apparatus 110 is lost when the CAN communication system fails. In particular, in the CAN communication system, because signals from a plurality of control systems are transmitted on a common communication bus 140, the failure rate is high when compared to transmission using individual communication buses, and this reduces reliability. Also, in addition to the CAN communication system, the control line 150 and communication bus 151 are wired separately, making the wiring cost high.

### SUMMARY OF THE INVENTION

Accordingly, in order to solve the above-noted problems, the present invention facilitates the effective use of the power supply output of the DC/DC converter even a different control system, and supplies electric power with high reliability.

The present invention provides a power supply controller that includes an electrical driving control means controlling the drive of a drive motor; an operating/driving control means different from the electrical driving control means, having an electrical actuator that uses power supplied from the main battery performs drive control of the electrical actuator to control an operating/driving condition of a vehicle; and a voltage conversion means converting the voltage of the main battery to a voltage that is suitable for use as the power supply for the electrical actuator of the operating/driving control means; the power supply controller controls the supply of electrical power to the electrical actuator from the main battery, wherein the electrical driving control means has a control command means that is communicatively connected to the voltage conversion means via a communication bus and that outputs, to the voltage control means, a control command controlling a voltage conversion operation of the voltage control means.

In this case, the electrical driving control means can be a hybrid control means that controls a hybrid system having an engine and the drive motor.

According to the aspect of the invention described above, the main battery used by the drive motor supplies electrical power to the electrical actuator of the operating/driving control means. In this case, the voltage of the main battery is supplied to the electrical actuator via the voltage conversion means that converts the voltage to an appropriate voltage. The electric driving control means (hybrid control means) that performs drive control of the drive motor outputs a direct control signal, via a communication bus, from the control command means to the voltage conversion means, controls the voltage conversion operation.

As a result, by using the electric driving control means (hybrid control means) to control the supply of power from the voltage conversion means to the operating/driving control means, it is possible to use the output of the voltage conversion means for even another operating/driving control means, thereby enabling effective utilization of the power output with high reliability. This is the because power supply control is not, in contrast to the conventional art, performed by a specific drive control means.

Essentially, because the voltage conversion means is placed under the control of the electric driving control means (hybrid control means), it becomes possible to use the output of the voltage conversion means for the operating/driving control means without any modification, thereby improving the scope of usability and universality.

Furthermore, the term operating/driving control means in this case refers to a means for controlling the operating or driving condition of a vehicle, such as steering control, brake control, vehicle attitude control, or body vibration suppression control or the like.

Another characteristic of the present invention is that when a problem occurs in the maint battery or after a prescribed amount of time has elapsed after the vehicle is started, the control command means outputs a disable command that disables voltage conversion operation.

By doing so, it is possible to perform proper voltage conversion operation and improve reliability. For example, if a main battery abnormality occurs in which the battery voltage is reduced below a prescribed voltage an unstable supply of power to the operating/driving control means may be prevented by disabling the voltage conversion operation.

Also, in general an initial diagnostic check is performed on the various driving systems of a hybrid system or the like for a prescribed period of time after the vehicle is started (i.e., after the ignition is switched on). During this period of time, safety may be improved by disabling the supply of power to the operating/driving control means,

Furthermore, the “prescribed amount of elapsed time” in the present invention may be any arbitrarily set period of time, such as the elapse of a prescribed period of time, the point at which a prescribed processing in the initial diagnostic check or the like is completed, or the point in time at which a prescribed status quantity is detected.

Another characteristic of the present invention is that the operating/driving control means may be an electric power steering apparatus that operates an electrical actuator to impart steering force to the steered wheels in response to the operation of the steering wheel.

In general, because an electric power steering apparatus consumes a large amount of electrical power, it is possible to perform proper operation of the actuators of the electrical motor and the like, and to generate an appropriate steering force by receiving electrical power from the high-voltage main battery that is used by the drive motor.

Yet another characteristic of the present invention is that when the ignition switch is set to off while the voltage conversion operation enable command is being output to the voltage conversion means, the control command means outputs a gradual-change command to the voltage conversion means, which gradually reduces the steering force imparted by the electric power steering apparatus. The voltage conversion means, in turn, outputs the gradual-change command to the electric power steering apparatus.

Thus, the command to gradually reduce the steering force of the electric power steering apparatus is given before the supply of power from the voltage conversion means is stopped. This avoids, therefore, problems such as a sudden change in the steering feel due to the sudden loss of steering force caused by the loss of power.

Furthermore, because the gradual-change command output from the control command means is sent to the electric power steering apparatus via the voltage conversion means, there is an additional cost advantage, because it is not necessary to have a communication bus, as in the past, which sends a signal from the hybrid control means to the electric power steering apparatus.

Yet another feature of the present invention is the provision of an auxiliary battery that has a lower voltage than the main battery used as the driving power supply for the drive motor, the voltage conversion means having a voltage-reducing circuit that reduces the voltage of the main battery, and a voltage-boosting circuit that boosts the voltage of the auxiliary battery, wherein when the voltage conversion operation enable command is received from the control command means, the voltage-reducing circuit is caused to operate and the electrical power of the main battery is output, and wherein when the command from the hybrid control means changes from the enable command to the disable command, the operation of the voltage-reducing circuit stops and the voltage-boosting circuit is caused to operate, to output the voltage of the auxiliary battery that is boosted to a prescribed voltage.

By doing the above, even when operation of the voltage conversion means is not enabled from the control command means and the main battery fails, it is possible to provide good operation of the operating/driving control means because the voltage conversion means boosts the voltage of the auxiliary battery and supplies power, thereby improving safety, reliability, and vehicle performance.

### BRIEF DESCRIPTION OF THE DRAWINGS

FIG. 1 shows the general configuration of the power supply system and signal transmission system of a power supply controller according to an embodiment of the present invention.

FIG. 2 is a simplified circuit configuration diagram of a power supply controller according to an embodiment of the present invention.

FIG. 3 is a timing diagram showing the command signal and voltage conversion operation in a power supply controller of the present invention.

FIG. 4 is a flowchart showing the power supply command control routine executed in the HV-ECU.

FIG. 5 is a flowchart showing the voltage-conversion control routine executed in the DC/DC controller.

FIG. 6 shows the general configuration of a communication control system.

FIG. 7 is a drawing that explains the signal waveforms in the communication control system.

FIG. 8 is a drawing showing the general configuration of the power supply system and signal transmission system in a conventional power supply controller.

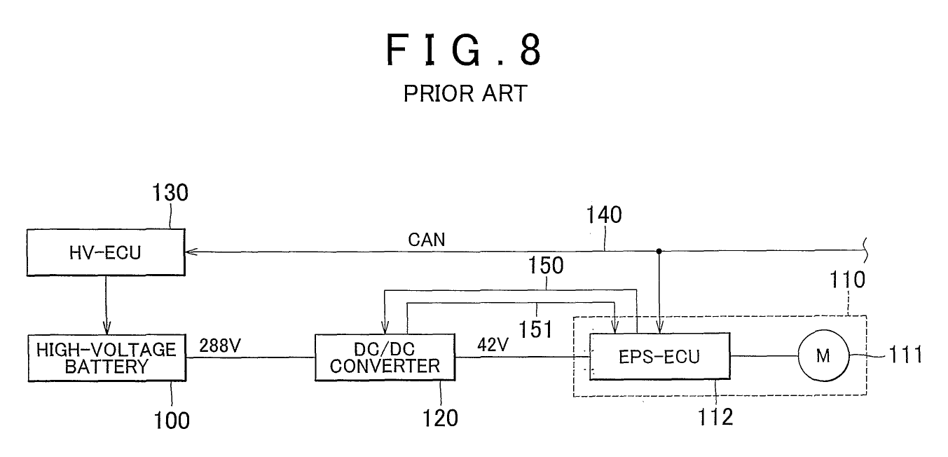

### DETAILED DESCRIPTION OF THE INVENTION

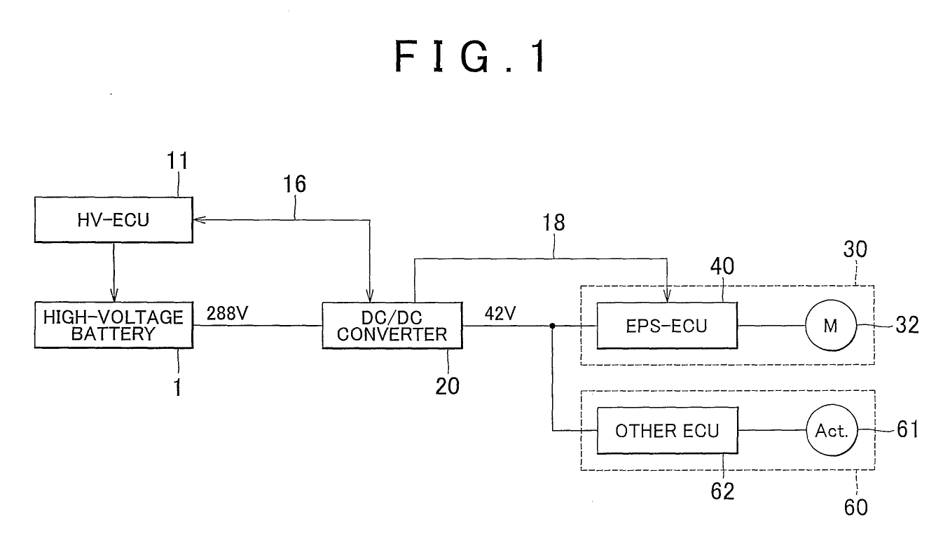

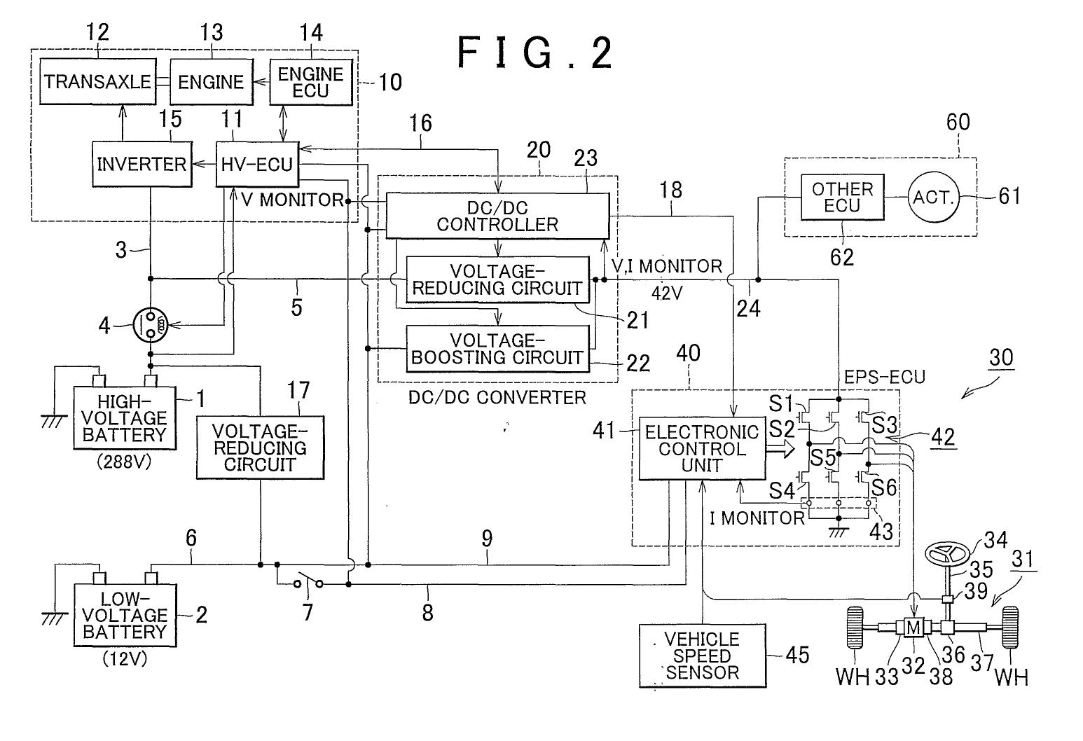

A power supply controller according to an embodiment of the present invention is described below, with reference made to drawings. FIG. 1 is a block diagram for describing in particular the power supply controller of this embodiment in comparison with a conventional power supply controller. FIG. 2 shows the general configuration of a power supply controller according to the embodiment.

The power supply controller is formed by a high-voltage battery (main battery) that is used as the drive power supply of a hybrid system 10, a low-voltage battery 2 (auxiliary battery) that is generally used by the vehicle control system, a DC/DC converter 20 that either reduces the voltage of the main battery or boosts the voltage of the low-voltage battery, and a hybrid controller 11 (hereinafter referred to as an HV-ECU) that controls the operation of the hybrid system 10 and also controls the operation of the DC/DC converter 20.

In this case, the abbreviation ECU stands for Electronic Control Unit.

The hybrid system 10 is described below.

The hybrid system 10 is provided with a transaxle 12, which is formed by a main motor, which is an electrical actuator for vehicle driving, a generator, a motive power distribution mechanism, a speed-reduction mechanism, and a differential gear (which are not illustrated), an engine 13, which is an internal combustion engine for driving the vehicle, an engine controller 14 (hereinafter referred to as the engine ECU 14), which controls the operation of the engine, and an inverter that converts DC power from the main battery 1 to three phases and powers and controls the main motor of the transaxle 12, and an HV-ECU 11, which controls operation within the hybrid system 10.

The main part of the HV-ECU 11 is formed by a microcomputer that calculates engine output and motor torque in response to the operating condition in accordance with the accelerator opening, the transmission shift position, and the signals from various sensors. The HV-ECU 11 then outputs to the engine ECU 14 a demanded value, and also controls the output of the inverter 15.

The main battery 1 used in this embodiment of the present invention, may be, for example, a battery having a rated voltage of 288 volts.

The main high-voltage power supply line 3, which supplies the power from the main battery 1, is connected to the inverter 15, and a system main relay 4 (hereinafter SMR 4) is provided midway therebetween for the purpose of switching between supply and cutoff of the high-voltage power supply.

A high-voltage power supply line 5 from the load side of the SMR 4 is branch connected to the main high-voltage 3, this high-voltage power supply branch line 5 supplying the DC/DC converter 20 with power from the main battery 1.

The low-voltage battery 2 used in this embodiment of the present invention is a general-purpose battery having a rated voltage of 12 volts.

The main low-voltage power supply line 6, which serves to supply the power from the low-voltage battery 2, is divided between the low-voltage power supply line 8, which is supplies electrical power linked to the on/off operation of the ignition switch 7, and the constantly on low-voltage power supply line 9, which supplies electrical power regardless of the on/off operation of the ignition switch 7, these each supply low-voltage power to the HV-ECU 11, the DC/DC converter 20, and the electric power steering apparatus 30. There are many other electrical loads that receive electrical power from the low-voltage battery 2, but these are not shown in FIG. 2.

A voltage-reducing circuit 21, which reduces the voltage of the high-voltage power supply line 3 of the main battery 1 to 12 volts, is connected to the high-voltage power supply line 3. The output of the voltage-reducing circuit 21 is connected to the main low-voltage power supply line 6.

The DC/DC converter 20 is formed by the voltage-reducing circuit 21, which reduces the 288-volt power supply supplied from the high-voltage power supply branch line 5 to a prescribed voltage (for example, 42 V in the case of this embodiment), a voltage-boosting circuit 22, which boosts the 12-V power supply supplied from the constantly on low-voltage power supply 9 to a prescribed voltage (for example, 33 V in the case of this embodiment), and a DC/DC controller 23, which controls the operation of the voltage-reducing circuit 21 and the voltage-boosting circuit 22.

The DC/DC controller 23 is joined to HV-ECU 11 by a single communication bus 16, through which thr DC/DC controller 23 can bidirectionally communicate with the HV-ECU 11.

The voltage-reducing circuit 21, for example, first converts the input voltage to alternating current by a transistor bridge circuit and, after reducing the voltage of the alternating current using a transformer, rectifies and smoothes the current to output DC power of a prescribed voltage.

The voltage-boosting circuit 22, for example, by intermittently causing current to flow in a voltage-boosting coil connected in series with the power supply line, generates electrical power in the voltage-boosting coil, and outputs the electrical power to boost the voltage.

The output terminals of the voltage-reducing circuit 21 and the voltage-boosting circuit 22 are both connected to the output line 24 of the DC/DC converter 24 (hereinafter referred to as the converter output line 24).

The DC/DC controller 23 monitors the voltage on the converter output line 24 and performs feedback control of the operation of the voltage-reducing circuit 21 or the voltage-boosting circuit 22 so that the output voltage is a target voltage, and also monitors the output current to check for the over-current condition.

The converter output line 24 is connected to the electric power steering apparatus 30 as a motor drive power supply, and is also connected to another operating/driving control apparatus 60. This other operating/driving control apparatus 60 may be, for example, a control system having a high power consumption, such as a suspension apparatus, a stabilizer apparatus, or a brake control apparatus having an electrical actuator 61 and an ECU 62 that controls the electrical actuator 61.

The electric power steering apparatus 30 is formed by a steering assist mechanism 31, which imparts steering assist force to the steered wheels WH, and a steering assist control unit 40 (hereinafter referred to as the EPS-ECU), which drive-controls an electric motor 32 provided in the steering assist mechanism 31.

The steering assist mechanism 31 converts the rotation of the steering wheel 34 about steering shaft 35 linked thereto to an axial-direction movement of a rack bar 37 using a rack-and-pinion mechanism 36, the left and right steered wheels WH being steered in response to the axial-direction movement of the rack bar 37. An electric motor 32 is built into the rack bar 37. The electric motor 32, by driving the rack bar 37 in the axial direction via a ball screw mechanism 38, in response to the rotation thereof, imparts assist force to the rotational operation of the steering wheel 34. A rotational angle sensor 33 that outputs a signal in response to the motor rotational angle is provided on the electric motor 32. A steering torque sensor 39 is built into the steering shaft 35.

The EPS-ECU 40 has an electronic controller 41, which calculates the amount of power to be supplied to the electric motor 32 for the purpose of imparting a prescribed steering assist force, and a motor drive circuit 42, which performs drive control of the electric motor 32 by means of a control signal from the electronic controller 41.

The motor drive circuit 42 is formed as a 3-phase inverter, which uses a group of 6 switching elements, S1, S2, S3, S4, S5, and S6 (MOSFETs in this embodiment), and supplies motor drive power from the converter output line 24 of the DC/DC converter 20. The motor drive circuit 42 is provided with a current sensor 43, which measures the amount of current flowing in each phase of the electric motor 32.

The electronic controller 41 inputs detection signals from the steering torque sensor 39 and the vehicle speed sensor 45, which detects the speed of the vehicle and calculates the amount of electrical power to be provided to the electric motor 32 based on these detection signals and, based on the signal of the rotational angle sensor 33 and the value detected by the current sensor 43, controls the amount of power provided to the electric motor 32, to generate the prescribed amount of steering assist force, the main part of the controller being formed by a microcomputer.

This electronic controller 41 is connected to the DC/DC controller 23 of the DC/DC converter 20 via the communication bus 18, to receive a gradual change command, to be described below, which is transmitted from the DC/DC controller 23.

The power supply control performed by the HV-ECU 11 and the DC/DC converter 20 will be described.

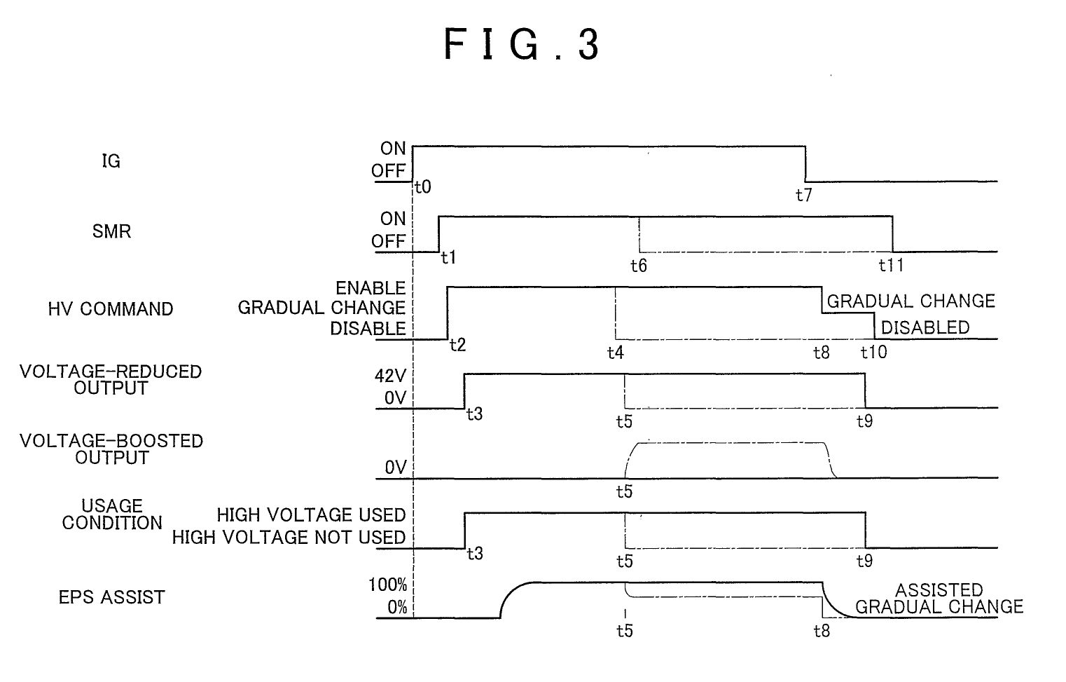

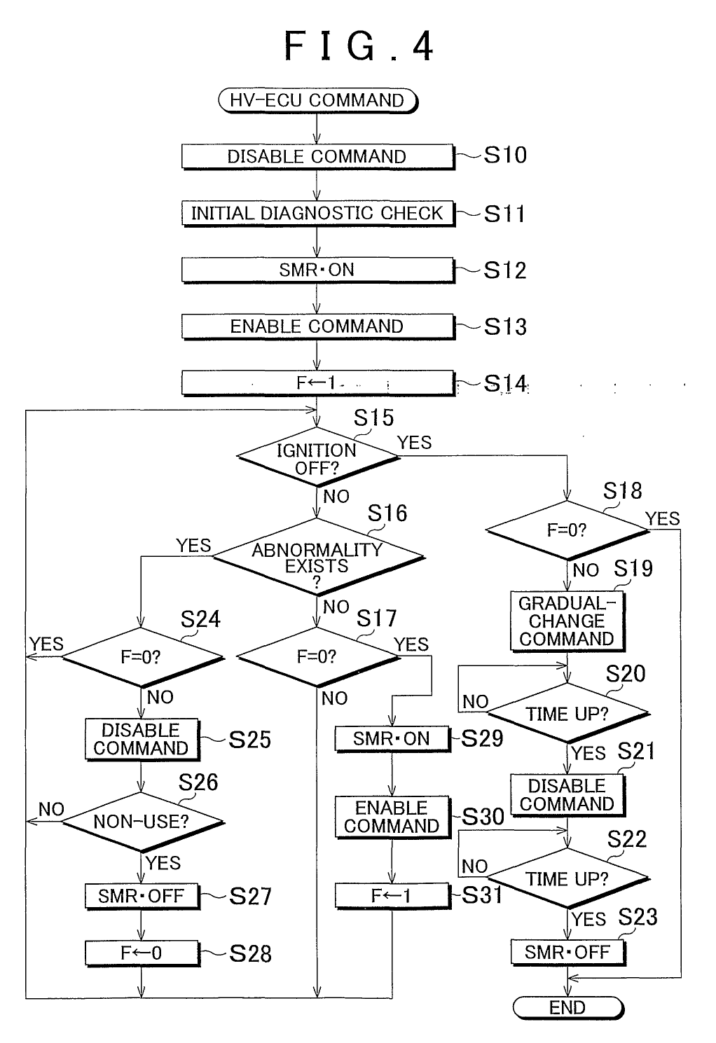

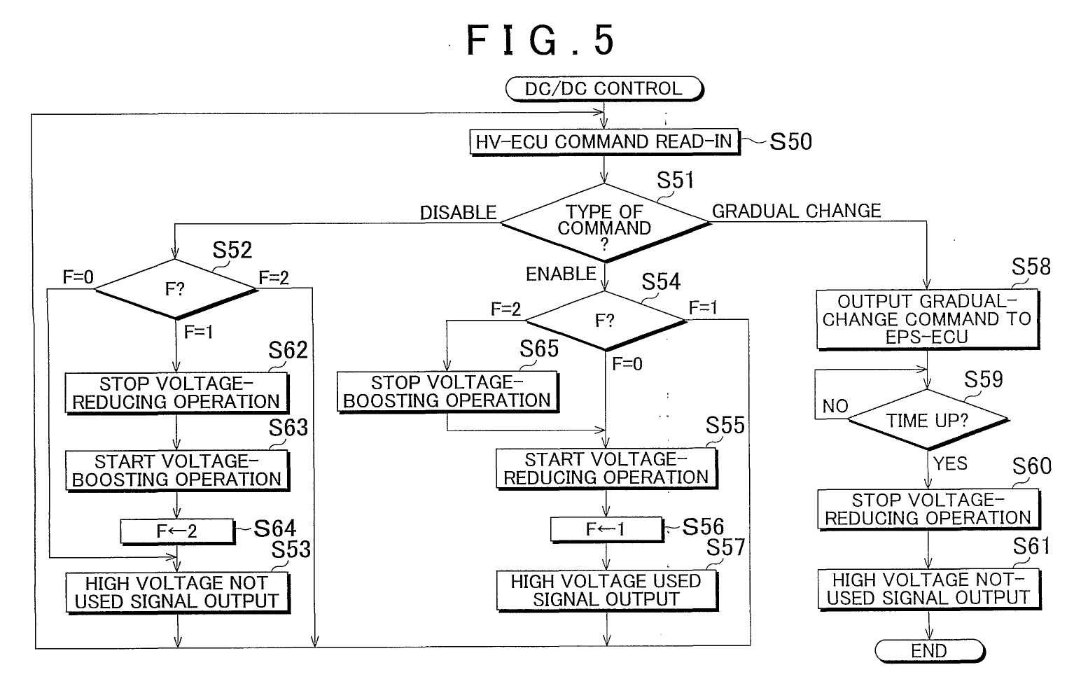

FIG. 3 shows a timing chart according to the power supply control in this embodiment. FIG. 4 is a flowchart showing a command control routine performed by the HV-ECU 11, and FIG. 5 is a flowchart showing a voltage conversion control routine performed by the DC/DC controller 23. They are stored as control programs in memory elements, which are not shown.

The command control routine and the voltage conversion control routine are performed in parallel. First, the command control routine performed by the HV-ECU 11 is described referring to FIG. 4 and FIG. 3.

This control routine starts when the ignition switch 7 is switched on. The HV-ECU 11 then outputs the disable command to the DC/DC controller 23 for a prescribed period of time (step S10). The initial diagnostic check of the hybrid system 10 is performed (step S11) during this period of time. When the initial diagnostic check is completed, the SMR 4 is switched on so that electrical power of the main battery 1 is supplied to the hybrid system 10 (step S12, time t1 in FIG. 3).

The prescribed period of time for outputting the disable command can be established either by measuring the elapsed time using a timer or when the initial diagnostic check is completed.

At the start of the control routine, the flag F is set to 0 because the SMR 4 is switched off, thus disabling the use of electrical power from the main battery 1. When the enable command is then output to the DC/DC controller 23, the SMR 4 is switched on to enable the use of electrical power from the main battery 1 (step S13, time t2 in FIG. 3) and the flag F is set to 1 (step S14).

The command signal output from the HV-ECU 11 to the DC/DC controller 23 is hereinafter referred to as the HV command.

Thus, the main battery 1 is connected to the DC/DC converter 20 when the SMR 4 is turned on and, in response to the enable command sent from the HV-ECU, the DC/DC controller 23 activates the voltage dropping circuit 21 to output 42-volt electrical power (time t2 in FIG. 3).

Although the control operation of the DC/DC converter 20 will be described hereinafter, with reference made to FIG. 5, related operation will be described in parallel below.

In a condition in which the secondary side of the DC/DC converter 20 outputs 42-volt electrical power, the HV-ECU 11 repeatedly checks the condition of the ignition switch 7 for the existence or non-existence of an abnormality, and the status of the flag F (steps S15, S16, and S17). An abnormality at step S16 is confirmed by checking abnormality in the hybrid system 10 and an abnormality (such as ground failure, voltage abnormality, and the like) of the main battery 1. Furthermore, the step S17 makes a judgment of “NO” because the flag F is set to 1 at the previous step S14.

Thus, as long as the ignition switch 7 is remains in the on position no abnormality is detected, this status does not change. This means that the SMR 4 remains in the on condition, and that the enable command continues to be output to the DC/DC controller 23 as well. During this time, therefore, electrical power at 42 volts, which is obtained by reducing the voltage of the power output by main battery 1, is supplied via the converter output line 24 to the electric power steering apparatus 30 and the other operating/driving control apparatus 60.

When the ignition switch 7 is set to off (time t7 in FIG. 3), a judgment of “YES” is made at step S15, processing then proceeding to step S18 to check the status of the flag F. In this case, because the flag F is to set 1, a move is made to the processing at step S19, the gradual-change command being output to the DC/DC controller 23 (time t8 in FIG. 3). This gradual-change command is a command which, in the case in which the converter output line 24 stops the supply of electrical power, gives prior notice of stoppage of the supply of power, thereby avoiding the sudden stop of the load function of the electric power steering apparatus 30 and the like.

Next, the HV-ECU 11 checks whether the prescribed period of time after outputting the gradual-change command has elapsed (YES at step S20), to output the disable command to the DC/DC controller 23 (step S21, time t10 in FIG. 3).

In this case, after the DC/DC controller 23 receives the gradual-change command and after the prescribed period of time has elapsed, the DC/DC controller 23 stops the voltage-reducing operation of the voltage-reducing circuit 21 (time t9 in FIG. 3).

The HV-ECU 11 then checks whether the prescribed period of time has elapsed after outputting the disable command (YES at step S22) to output the cutoff signal to the SMR 4 for cutting off the high-voltage power supply to the hybrid system 10, to complete this control routine (step S23).

Alternatively, when the ignition switch 7 is switched on (NO at step S15) and an abnormality is detected in a condition in which the voltage-reducing circuit 21 reduces the voltage (YES at step S16), processing proceeds to step S24 to check the status of the flag F. In this case, because the flag F has been set to 1 processing moves to step S25, the disable signal being then output to the DC/DC controller 23 (time t4 in FIG. 3). After reading the usage status signal from the DC/DC controller 23, and waiting to receive the high-voltage-not-used signal (time t5 in FIG. 3), the SMR 4 is switched off (step S27, time t6 in FIG. 3). The flag F is then set to 0 (step S28), so that this status is caused to continue thereafter.

In this manner, when detecting an abnormality, the SMR 4 is switched off to cut off the supply of power from the main battery 1. For example, when the supply of power from the main battery 1 falls below the prescribed voltage, since the SMR 4 is switched off due to a battery abnormality, abnormal operation of the hybrid system 10, as well as unstable supply of power to the controller that is supplied electrical power from the converter output line 24, such as the electric power steering apparatus 30, are prevented, thereby improving safety.

Furthermore, when an abnormal status is detected and the SMR 4 is switched off to cut off the supply of power from the main battery 1, if the judgment of checking abnormality switches to “no abnormality” (NO at step S16), processing proceeds to step S17. In this case, the flag F has been set to 0 so that the judgment of “YES” is made, and the processing moves to step S29. The SMR 4 is switched on to enable the condition in which the power of the main battery 1 is usable, and also the enable command is output to the DC/DC controller 23 (step S30), the flag F being then set to 1 (step S31).

For example, in the case in which the power supply voltage of the main battery 1 is restored from the reduced-voltage condition to the reference voltage condition, the judgment of the step S16 changes “abnormality” to “no abnormality.” With the recovery to normal, the SMR 4 is switched on to output the enable command to the DC/DC controller 23.

This processing is repeated until the ignition switch 7 is switched off, at which time, as mentioned above, the gradual-change command and the disable command are output so that the SMR 4 is switched off, thereby ending this control routine.

Additionally, if the ignition switch 7 is switched off when the disable command is output, the step S18 makes a judgment of “YES”, and this control routine is terminated as is.

Next, the voltage conversion control processing performed by the DC/DC controller 23 is described below, based on the flowchart of FIG. 5 and the timing chart of FIG. 3.

This control routine is performed in parallel with the command control routine performed by the HV-ECU 11 described above, and is started when the ignition switch 7 is set to on.

First, a command is read in from the HV-ECU 11 (step S50), and a judgment is made as to the type of command (step S51). At the start, the HV-ECU 11 outputs a disable command. For this reason, at this point there is a move to step S52, at which the setting condition of the flag F is checked.

This flag F is different from the flag F that is used in the previously described command control routine, and represents the operating status of the DC/DC converter 20. When the voltage-reducing circuit 21 and voltage-boosting circuit 22 are not operating, F=0, when the voltage-boosting circuit 21 is operating, F=1, and when the voltage-boosting circuit 22 is operating, F=2. When this control routine is started, the setting is F=0.

When the vehicle is started, therefore, the judgment at step S52 is that F=0, so that a move is made to step S53, and the high-voltage not used signal is output to the HV-ECU 11.

The DC/DC controller 23 continuously outputs a usage condition signal to the HV-ECU 11, this indicating whether or not the electrical power of the main battery 1 is being used, and when the voltage-reducing circuit 21 is not caused to operate, this high-voltage-not-used signal is output. Then, the command signal is read in from the HV-ECU 11 at step S50. This reading in of the command signal (HV command) is repeated, and when the enable signal is received from the HV-ECU 11 (enable at step S51, time t2 in FIG. 3), the setting status of the flag F is checked (step S54). In this case, because the flag F had been set to 0 up before the immediately previous time, the judgment at step S54 is F=0, the operation of the voltage-boosting circuit 21 is started (step S55) as the flag F is set to 1 (step S56) and the high-voltage used signal is output to the HV-ECU 11 (step S57, time t3 in FIG. 3).

When the voltage-reducing circuit 21 starts to operate, the DC/DC controller 23 monitors the output voltage thereof and adjusts the voltage so that the output voltage is a target voltage (42 volts in this embodiment), and the output current is monitored as well and, when an over-current condition is detected, an over-current signal is output to the electronic controller 41 of the EPS-ECU 40, via the communication bus 18. The electronic controller 41 adjusts the motor drive circuit 42, in particular, the upper limit value of the amount of electrical power fed to the electrical motor 32 is lowered, to prevent overheating of the voltage-reducing circuit 21.

In this manner, the voltage-reducing circuit 21 starts to operate, and when electrical power is supplied from the main battery 1 to the electrical power steering apparatus 30 and also the other operating/driving controller 60, this condition is maintained until the command from the HV-ECU 11 changes (F=1 at step S54).

Accompanying the start of operation of the voltage-reducing circuit 21, the DC/DC controller 23 sends a signal, via the communication bus 18, to the electronic control unit 41 indicating that the supply of power from the main battery 1 will start. The EPS-ECU 40, based on the signal, begins assist control at 100% capacity.

In the electrical power steering apparatus 30, therefore, high-voltage electrical power is supplied and it is possible to achieve sufficient steering assist torque.

In this condition, if the ignition switch 7 is switched off (time t7 in FIG. 3), as noted above, the HV-ECU 11 sends a gradual-change command to the DC/DC controller 23 (time t8 in FIG. 3). Then, when the DC/DC controller 23 receives the gradual-change command from HV-ECU 11 (gradual change at step S5 1), a gradual-change command is output to the electronic controller of the EPS-ECU 40 (step 58). This gradual-change command is an indication that the supply of electrical power from the main battery 1 will be stopped.

When the EPS-ECU 40 receives the gradual-change command, the upper limit value of the current supplied to the electric motor 32 is gradually reduced, to gradually reduce the steering assist torque. Essentially, the amount of steering assist torque capacity is gradually reduced, so that there is no sudden change in the steering feel when the steering assist torque is suddenly lost because of the stoppage of the supply of electrical power.

After the command output at step S58, and after waiting for a prescribed period of time to elapse, the operation of the voltage-reducing circuit 21 is stopped (step S60, time t9 in FIG. 3). The timing of stopping the voltage-reducing operation is established by measuring a time that is set considering the amount of time required for the gradual-change operation of the EPS-ECU 40, using a timer (step S59).

Simultaneous with the stop of operation of the voltage-reducing circuit 21, a high-voltage-not-used signal is output to the HV-ECU 11 (step 61), and this control routine ends.

The HV-ECU 11, based on the high-voltage-not-used signal output from the DC/DC controller 23, switches the SMR 4 to off, thereby cutting off the supply of power by the main battery.

During the operation of the voltage-reducing circuit 21, when a disable command is sent from the HV-ECU 11 (time t4 at FIG. 3), the judgment at step S51 changes from “enable” to “disable,” after which the status of the flag F is checked at step S52.

Immediately after the command from the HV-ECU 11 changes from “enable” to “disable,” because the flag F is set to 1, the judgment at step S52 is F=1, and at steps S62 and S63 the operation of the voltage-reducing circuit 21 is stopped and the operation of the voltage-boosting circuit 22 is started (time t5 at FIG. 3), respectively. The flag F is then set to 2 (step S64), and a high-voltage-not-used signal is output to the HV-ECU 11 (step S53).

Thus, by stopping the operation of the voltage-reducing circuit 21, the supply of electrical power between the main battery 1 and the electrical power steering unit 30 or other operating/driving controller 60 is cut off, and by starting the operation of the voltage-boosting circuit 22, the voltage of the low-voltage battery 2 to the electrical power steering unit 30 or other operating/driving controller 60 may be boosted, and supply of electrical power is started. In this case, in addition to starting the operation of the voltage-boosting circuit 22, the DC/DC controller 23 sends a signal indicating that the supply of electrical power from the low-voltage battery 2 to the electrical control unit 41 of the EPS-ECU 40 has started, via the communication bus 18. The EPS-ECU 40 then, based on this transmission, activates a low-power mode in which the electrical power steering unit 30 operates at or below a prescribed electrical power.

As long as the command from the HV-ECU 11 is not switched, the voltage-boosting operation with respect to the low-voltage battery 2 continues.

When this voltage-boosting operation is performed on the low-voltage battery 2, in the case in which the command from the HV-ECU 11 switches from “disable” to “enable,” the judgment at step S51 becomes “enable,” and the status of the flag F is checked at step S54. In this case, because the flag F is set to 2, processing proceeds to step S65, at which the voltage-boosting operation of the voltage-boosting circuit 22 is stopped. A move is then made to step S55, at which the operation of the voltage-reducing circuit 21 is restarted, the flag F being set to 1 (step S56) and a high-voltage used signal being output to the HV-ECU 11 (step S57).

In a routine such as this, a command from the HV-ECU 11 switches the operation of the DC/DC converter 20. For this reason, because the operation of the DC/DC converter 20 is not controlled from the EPS-ECU 40, as is conventionally done, it is possible to make stable use of the output of the DC/DC converter 20 for the other operating/driving controller 60. Essentially, because the DC/DC converter 20 is placed under control of the HV-ECU 11, it is possible to use the output of the DC/DC converter 20 not only for the electrical power steering apparatus 30, but also for various operating/driving controllers 60, thereby broadening the range of usefulness and increasing the general usability as a power supply.

Because, in contrast to the past, the CAN communication system is not used to send a voltage-conversion command, it is possible to reduce the amount of data transferred within the CAN, thereby enabling a commensurate reduction in the burden on the CAN communication system.

Additionally, it is possible to reduce the wiring cost for the communication bus in comparison with conventional systems.

When an abnormality such as insufficient battery voltage or the like occurs, by disabling the use of the power from the main battery 1, it is possible to prevent supply of unstable power to the electrical power steering apparatus 30 or other operating/driving controller 60.

Additionally, even in the case in which the use of the electrical power from the main battery 1 is disabled, because electrical power is supplied by boosting the voltage of the low-voltage battery 2, it is possible to achieve good operation of the electrical power steering apparatus 30 and the actuator 61 of the other operating/driving controller 60, thereby improving safety, reliability, and vehicle performance.

Furthermore, the functional part of the HV-ECU 11 that implements the command control routine shown in FIG. 4.

Next, the bidirectional simultaneous communication between the HV-ECU 11 and the DC/DC controller 23 is described below.

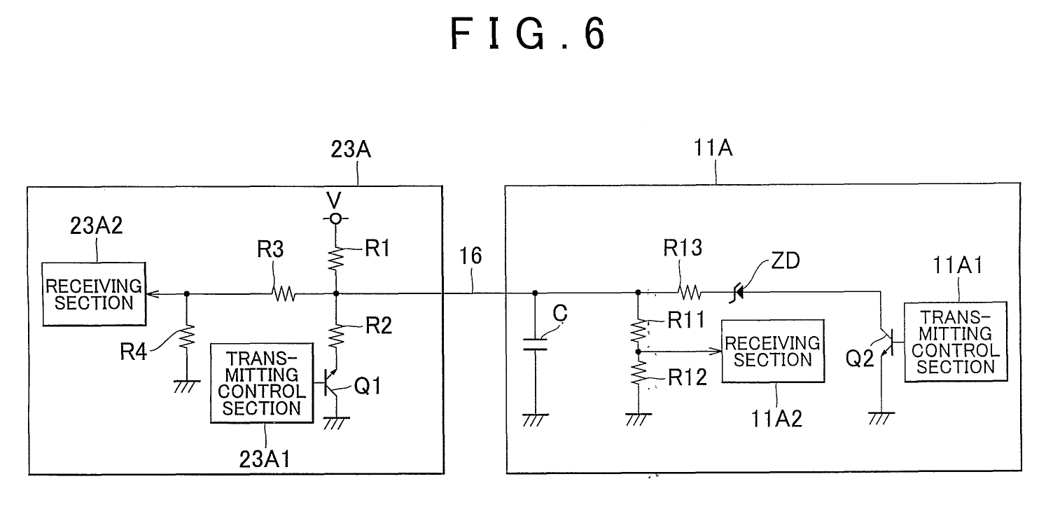

FIG. 6 shows the configuration of the communication section in the HV-ECU 11 and the DC/DC controller 23, the left side of the drawing shows the communication section 23A of the DC/DC controller 23, and the right side of the drawing shows the communication section 11A of the HV-ECU 11.

The communication section 23A of the DC/DC controller 23 is formed by the resistors R1, R2, R3, and R4, the transistor Q1, the transmitting controller 23A1, and the receiving section 23A2.

The communication bus 16 is connected to the point between resistor R1 and resistor R2, which are provided in series between a power supply line V of a prescribed voltage and ground within the circuit.

The transmitting controller 23A1 outputs a control signal to the base of the transistor Q1, which serves as a switching element provided in series with the resistors R1 and R2, and switches the state of the transistor Q1 on and off. Thus, the transmitting controller 23A1, by switching the transistor Q1 on and off, changes the voltage that is output to the communication bus 16, and transmits an operating status signal (operating status data) of the DC/DC converter 20 to the HV-ECU 11. Essentially, during operation of the voltage-reducing circuit 21 of the DC/DC converter 20, a “high voltage used” signal is sent, and during non-operation of the voltage-reducing circuit 21, a “high voltage not used” signal is sent.

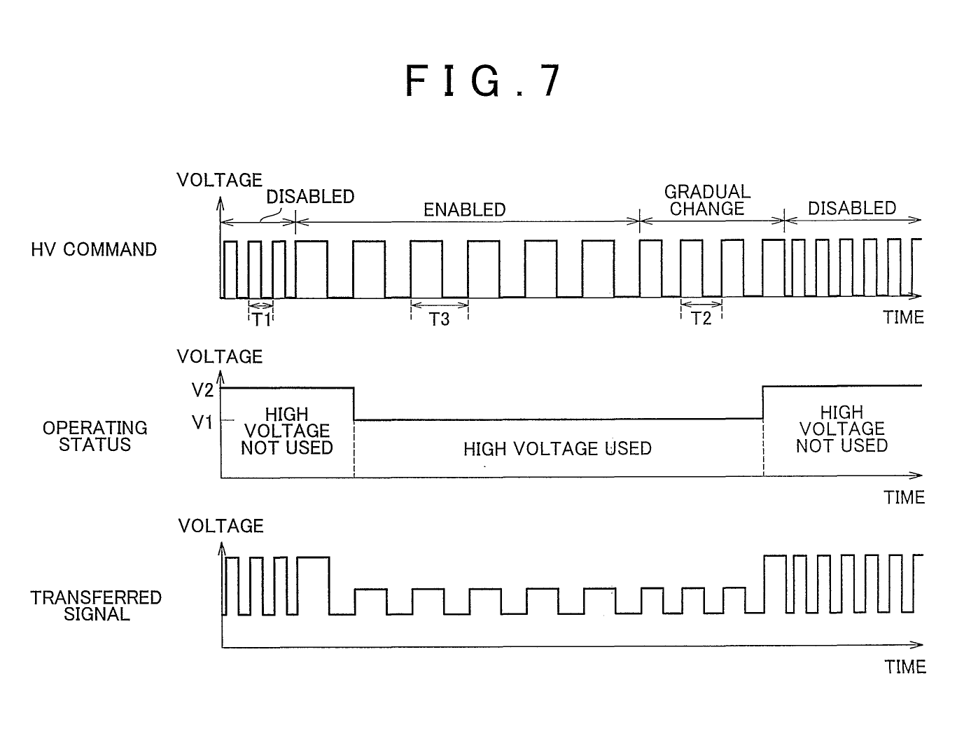

In this case, the transmission controller 23A1, as shown in the middle part of FIG. 7, in the case of “high voltage used,” sets the transistor Q1 to on and sets the operation status signal to a prescribed first voltage V1. In the case of “high voltage not used,” it sets the transistor Q1 to off, and sets the operation status signal to a prescribed second voltage V2 (where V2>V1). Essentially, in the communication section 23A, voltage amplitude modulation is used, in which the transmitted signal (transmitted data) is switched by switching the magnitude of the output voltage.

The operating status signal waveforms in FIG. 7 are shown as the output terminal voltage waveforms with the communication bus 16 in the open condition.

The communication section 23 is provided with a resistor R3 in series with the communication bus 16, and a receiving section 23A2, which reads a signal transmitted from the communication section 11A of the HV-ECU 11, at the connection point between resistor R4, one end of which is grounded, and R3.

The communication section 11A of the HV-ECU 11 is formed by the resistors R11, R12, and R13, the zener diode ZD, the transistor Q2, the capacitor C, the transmitting controller 11A1, and the receiving section 11A2. The series connected resistor R13, zener diode ZD, and transistor Q2 are provided between the communication bus 16 and ground, in parallel to which is provided the series connected resistors R11 and R12 and the capacitor C, which serve as a noise filter.

The communication controller 11A1 outputs a pulse signal to the base of transistor Q2, which serves as a switching element, to switch the state of the transistor Q2 on and off.

In this case, a pulse signal having a prescribed duty ratio (50% in this embodiment) is output to the base of the transistor Q2, and by changing the period of the pulse signal, the HV command signal that is transmitted to the communication bus 16 is switched.

Essentially, the HV-ECU 11 transmits an HV command signal (HV command data) that represents “enable,” “disable,” and “gradual change” to the DC/DC controller 23, and by varying the period of the pulse signal that is input to the transistor Q2, pulse period modulation is used which switches these three command signals.

In this example, as shown in the upper part of FIG. 7, the HV command signal has the “disable” command signal period set to the shortest period T1, the “enable” command signal set to the longest period T3. The “gradual change” command signal is set to the period T2 that is between these two (that is, T1<T2<T3).

The receiving section 11A2 is provided at the connection node between resistors R11 and R12, to read the voltage value at that connection node, thereby reading the signal that is sent from the communication section 23A of the DC/DC controller 23.

The zener diode ZD floats the HV command signal above ground by a prescribed voltage (that is, holds it at a prescribed voltage or above), and in the case in which an on-fault (ground short fault) occurs within the circuit, this fault can be detected thereby.

The communication sections 11A and 23A configured in this manner are joined by a single communication bus 16. Thus, the output waveforms of the signals transmitted on this communication bus 16, as shown in the lower part of FIG. 7, are synthesized from the HV command signal and the operating status signal.

At the receiving section 1 1A2 in the communication section 11A of the HV-ECU 11, the voltage between the resistors R11 and R12 is converted to a digital signal by an A/D converter (not illustrated), and by reading the transmitted signal voltage, this being the voltage amplitude of the pulse signal, a judgment is made as to the type of signal (“high voltage used” or “high voltage not used”) transmitted from the DC/DC controller 23.

At the receiving section 23A2 in the communication section 23A of the DC/DC controller 23, the edge of the pulse signal (rising edge or the falling edge of the pulse signal) is detected by a voltage change at the connection node between resistor R3 and resistor R4, to determine the period of the pulse signal. In this manner, a judgment is made as to the type of HV command signal (“disable,” “enable,” or “gradual change”) output from the HV-ECU 11.

According to the communication system between the HV-ECU 11 and DC/DC controller 23 described above, the HV command signal output from the HV-ECU 11 is distinguished by the pulse period, and also with regard to an important signal such as a disable command, by making the period of that command short, the transmission speed of the signal is increased.

For this reason, it is possible to quickly detect a disable signal at the DC/DC controller 23, and stop the supply of power from the main battery 1 quickly when an abnormality is detected, to improve safety, and vehicle reliability.

Also, when performing bidirectional communication using only voltage modulation, if an error is included, the setting range of the threshold value is narrowed. In this embodiment, however, by using a combination with pulse period modulation, this problem is also eliminated.

Although an embodiment of a power supply according to the present invention is described above, it will be understood that the present invention is not restricted to the above-noted embodiment, a number of diverse variations being possible within the scope of the object of the present invention.

For example, although in the above-described embodiment the description is of a power supply controller using a high-voltage battery power source in a hybrid system 10, the power supply controller may also be applied in an electrical vehicle that uses a high-voltage battery.

Additionally, it is possible to adopt a configuration such that when the the ignition switch 7 is detected as being switched off, a gradual-change command may be output not only to the electrical power steering apparatus 30 but also to another operating/driving controller 60.

Although the above embodiment is configured to provide a voltage-boosting circuit 22 within the DC/DC converter 20, so that when an abnormality of the main battery 1 occurs a voltage-boosted power supply from the low-voltage battery 2 is supplied, it is possible to adopt a configuration in which the voltage-boosting circuit 22 is omitted.

The DC/DC converter may also be a voltage conversion apparatus that further boosts the voltage of the high-voltage battery.

The operating/driving controller to which the DC/DC converter supplies is not limited to an electric power steering apparatus, and may be, for example, an electrical brake controller, a vehicle attitude controller, or a body vibration suppression controller or other type of apparatus that controls the operating condition or driving condition of a vehicle.

The voltage values (battery voltage, reduced voltage, and boosted voltage) and the like in the embodiment described are merely exemplary, and may be arbitrarily set.

1-6. (canceled)

7. A power supply controller comprising:
a main battery that supplies driving power to a drive motor;
an electrical driving control device that controls electrical power supplied from the main battery and controls the drive motor;
an operating/driving control device that controls an operating/driving condition of a vehicle, includes an electrical actuator powered by the main battery, and controls the electrical actuator; and
a voltage conversion device that converts a voltage of the main battery to a voltage that is suitable for use as a power supply for the electrical actuator of the operating/driving control device;
wherein the electrical driving control device includes a control command device that is communicatively connected to the voltage conversion device via a communication bus, and that outputs a control command to the voltage conversion device to control a voltage conversion operation of the voltage conversion device.

8. A power supply controller according to claim 7, wherein the electrical driving control device is a hybrid control device that controls a hybrid system having an engine and the drive motor.

9. A power supply controller according to claim 7, wherein the control command device outputs a disable command that disables voltage conversion operation when an abnormality exists in the main battery, or until a prescribed period of time has elapsed after the vehicle is started.

10. A power supply controller according to claim 7, wherein the operating/driving control device is an electric power steering apparatus that operates an electrical actuator to impart a steering force to a steered wheel in response to an operation of a steering wheel.

11. A power supply controller according to claim 10, wherein the control command device outputs a gradual-change command to the electric power steering apparatus, via the voltage conversion device, when an ignition switch is switched off while an enable command for a voltage conversion operation is output to the voltage conversion device, and
the gradual-change command causes the electric power steering apparatus to gradually reduce the steering force imparted by the electric power steering apparatus.

12. A power supply controller according to claim 7, further comprising:
an auxiliary battery that has a lower voltage than the main battery, and wherein
the voltage conversion device includes a voltage-reducing circuit that reduces the voltage of the main battery and a voltage-boosting circuit that boosts the voltage of the auxiliary battery, starts operation of the voltage-reducing circuit to output the main battery electrical power when receiving an enable command for the voltage conversion operation from the control command device, and stops operation of the voltage-reducing circuit and starts operation of the voltage-boosting circuit to output and boost the voltage of the auxiliary battery to a prescribed voltage when receiving a disable command from the control command device.
